(19) United States
(12) Patent Application Publication
(10) Pub. No.: US 2025/0124790 A1
(43) Pub. Date: Apr. 17, 2025

(54) SYSTEMS AND METHODS FOR PREDICTING PROBABILITY OF VEHICLE PASSAGE DURING TRAFFIC LIGHT GREEN PHASE

(71) Applicant: Ford Global Technologies, LLC, Dearborn, MI (US)

(72) Inventor: Aed M. Dudar, Canton, MI (US)

(73) Assignee: Ford Global Technologies, LLC, Dearborn, MI (US)

(21) Appl. No.: 18/486,858

(22) Filed: Oct. 13, 2023

(51) Int. Cl. G08G 1/0967

(52) U.S. Cl. CPC G08G 1/096783

(57) ABSTRACT

A method to determine a probability of a first vehicle crossing a traffic light in green phase is disclosed. The method may include obtaining information associated with a green light duration, first vehicle information, and second vehicle information. The first vehicle information may include historical rate of change of speed profile associated with the first vehicle, and the second vehicle information may include a first time duration required by the second vehicle to cross the traffic light. The method may further include estimating a second time duration required by the first vehicle to cross the traffic light based on the first and second vehicle information, and comparing the second estimated time duration with the green light duration. The method may include determining a probability of the first vehicle crossing the traffic light in the green light duration based on the comparison, and transmitting a notification to indicate the probability.

### FIELD

The present disclosure relates to systems and methods for predicting a probability of vehicle passage during a green phase of a traffic light.

### BACKGROUND

When a vehicle arrives in proximity to a traffic light, a vehicle driver may not be aware when the traffic light may change its phase from red to green or vice versa. Further, the vehicle driver may not be aware whether the vehicle may be able to cross the traffic light in the green phase when the vehicle may be travelling towards the traffic light. Since the vehicle driver may not be aware of such information in advance, the vehicle driver may move fast, slow down and stop in proximity to the traffic light depending on the real-time traffic light phase. Such vehicle movement may cause inconvenience to other vehicle drivers.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system for predicting a vehicle probability to cross a traffic light in accordance with the present disclosure.

FIG. 3 depicts a first example snapshot of a plurality of vehicles disposed in a queue in proximity to a traffic light in accordance with the present disclosure.

FIG. 4 depicts a second example snapshot of a plurality of vehicles disposed in a queue in proximity to a traffic light in accordance with the present disclosure.

FIG. 5 depicts an example message being displayed on a vehicle infotainment system in accordance with the present disclosure.

FIG. 6 depicts a flow diagram of an example method for predicting a vehicle probability to cross a traffic light in accordance with the present disclosure.

### DETAILED DESCRIPTION

### Overview

The present disclosure describes a vehicle (e.g., a first vehicle) configured to determine a probability of vehicle passage in a green phase of a traffic light. The first vehicle may obtain first vehicle information (associated with the first vehicle), second vehicle information (associated with a second vehicle in front of the first vehicle in a vehicle queue in proximity to the traffic light), and real-time traffic signal information associated with the traffic light. The first vehicle may be configured to estimate a first time duration that may be required by the first vehicle to cross the traffic light based on the first vehicle information and the second vehicle information. Responsive to the estimating the first time duration, the first vehicle may determine the probability of vehicle passage in the traffic light green phase based on the real-time traffic signal information and the estimated first time duration.

In some aspects, the first vehicle information may include historical rate of change of speed profile associated with the first vehicle. The historical rate of change of speed profile may be different for different vehicle types (e.g., Electric Vehicles (EVs), fuel cell vehicles (FCVs), diesel based Internal Combustion Engine (ICE) vehicles, gasoline-based ICE vehicles, vehicles with electrified turbocharger, and/or other vehicle types). The second vehicle information may include a second time duration that may be required by the second vehicle to cross the traffic light, a second distance that the second vehicle may have to travel to cross the traffic light. The real-time traffic signal information may include green light duration associated with the green light phase.

In some aspects, when the first vehicle arrives in proximity to the traffic light, the first vehicle may determine a first vehicle position in the vehicle queue. For example, the first vehicle may determine whether other vehicles are present in front of the first vehicle (e.g., by using inputs from vehicle exterior cameras). Responsive to determining that no vehicle may be present in front of the first vehicle, the first vehicle may determine that the first vehicle may be at the first position in the queue. In this case, the first vehicle may broadcast the first vehicle position to the other vehicles that may be present behind the first vehicle, to enable the other vehicles to calculate their respective positions in the vehicle queue. The first vehicle may then calculate a first distance that the first vehicle may have to travel to cross the traffic light, based on a first vehicle length and a distance/gap between first vehicle front portion and a centerline of an intersection at which the traffic light may be disposed. The first vehicle may then estimate the first time duration based on the first distance and the historical rate of change of speed associated with the first vehicle, and determine probability of whether the first vehicle may cross the traffic light in the green phase based on the first time duration and the green light duration. The first vehicle may then broadcast the calculated first distance and the first time duration to other vehicles located behind the first vehicle.

On the other hand, when the first vehicle determines that the first vehicle may be disposed at a second position (or any other position) in the vehicle queue, the first vehicle may calculate the first distance based on the second distance, the first vehicle length, and a gap between the first vehicle and the second vehicle. In addition, in this case, the first vehicle may estimate the first time duration based on the first distance, the second time duration, and the historical rate of change of speed profile, and accordingly determine the probability. Stated another way, in this case, the first vehicle may estimate the first time duration based on the time duration the second vehicle in front of the first vehicle may take to cross the traffic light. In some aspects, if the second vehicle may be an EV, the second vehicle may have a higher rate of change of speed profile, and hence may cross the traffic light quicker (hence increase the probability of the first vehicle crossing the traffic light in the green phase), as compared to when the second vehicle may be an ICE vehicle. Note, the speed of the vehicle and the speed profile of the vehicle should always maintain the vehicle within the lawful speed limit, and at all times at a safe speed for the given conditions. In further aspects, if the second vehicle is diesel-based ICE, the second vehicle may have a higher rate of change of speed profile, and hence may cross the traffic light quicker, as compared to when the second vehicle may be a gasoline-based ICE vehicle.

The present disclosure discloses a system and method for determining a probability of a vehicle crossing a traffic light in green phase. The system enhances vehicle driving experience and Estimated Time of Arrival (ETA) for vehicle drivers. The system further enables traffic control models to better estimate the traffic flows in cities and urban areas. The system further reduces likelihood of vehicle drivers trying to cross a yellow or red light by not knowing ahead of time whether there is a good chance of passing the traffic light in green phase.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

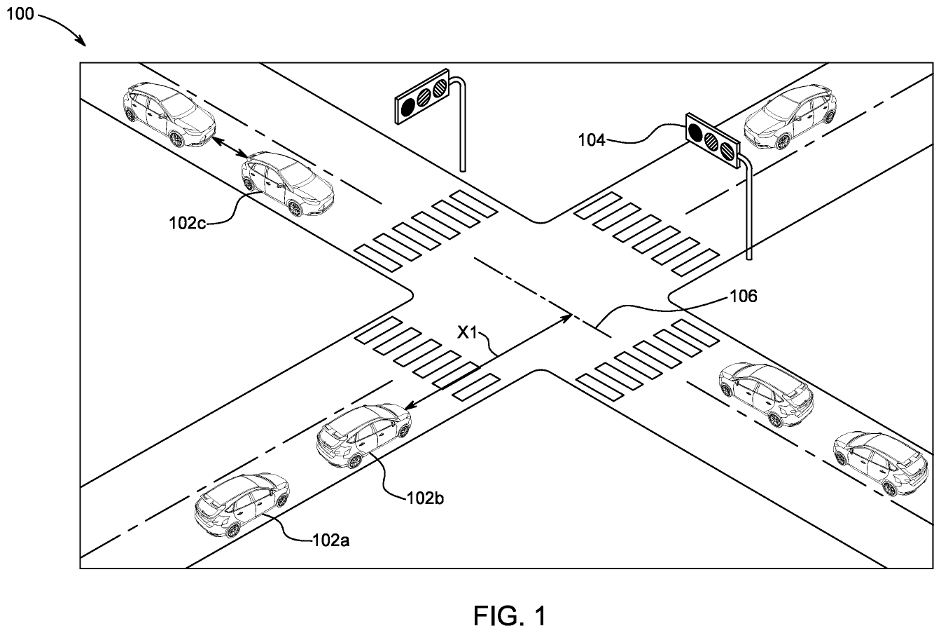

FIG. 1 depicts an example environment 100 in which techniques and structures for providing the systems and methods disclosed herein may be implemented. The environment 100 may include one or more vehicles 102a, 102b, 102c etc. (collectively referred as vehicle 102) that may be travelling on a road including one or more traffic lights 104 (or a traffic light 104). The vehicle 102 may take the form of any passenger or commercial vehicle such as, for example, a car, a work vehicle, a crossover vehicle, a truck, a van, a minivan, a taxi, a bus, etc. The vehicle 102 may be a manually driven vehicle, and/or may be configured to operate in a partially autonomous mode, and may include any powertrain such as, for example, a gasoline engine, one or more electrically-actuated motor(s), a hybrid system, etc.

The traffic light 104 may be configured to operate on a fixed schedule or may be dynamically actuated by a traffic light control server (not shown) based on traffic, weather, etc. conditions on the road in proximity to the traffic light 104. In some aspects, when the traffic light 104 operates on a fixed schedule, actuation of a traffic signal phase (e.g., a green phase when the traffic light 104 emits green light, a yellow phase when the traffic light 104 emits yellow light, or a red phase when the traffic light 104 emits red light) may follow a fixed time schedule. For example, when the traffic light 104 operates on a fixed schedule, the traffic light 104 may be in the green phase for 90 seconds, followed by the yellow phase for 5 seconds, and then the red phase for 60 seconds. In this case, the timing or time duration of each phase (e.g., 90 seconds for green phase, 5 seconds for yellow phase and 60 seconds for red phase) remains constant or fixed, irrespective of a flow of traffic or vehicles on the road. Further, a total time duration of a “traffic signal cycle” may also remain constant in this case. In some aspects, the traffic signal cycle, as described in the present disclosure, means a cycle of traffic light operation that starts with the commencement of a green phase and ends at the beginning of a next green phase.

On the other hand, when the traffic light 104 may be dynamically actuated (e.g., by the traffic light control server) based on traffic on the road, actuation of a traffic signal phase (i.e., the green phase, the red phase or the yellow phase) may not follow a fixed pattern. Further, a time duration for which the traffic light 104 may operate in each phase may also not be fixed. Furthermore, in this case, the total time duration of a traffic signal cycle may or may not be fixed.

For the description of the present disclosure, the traffic light 104 is assumed to operate on a fixed schedule. Further, for the sake of simplicity, red phase and yellow phase are considered as red phase.

In some aspects, each vehicle 102 may be configured to determine a probability of the vehicle 102 crossing a traffic light (e.g., the traffic light 104) in the green phase based on vehicle's own information, information associated with other vehicles that may be located in front of the vehicle 102 in a queue in proximity to the traffic light 104, and traffic signal information associated with the traffic light 104. For example, if the vehicle 102a (or “a first vehicle”) may be located in proximity to the traffic light 104 and behind the vehicle 102b (or “a second vehicle”), the vehicle 102a may determine its probability to cross the traffic light 104 in the green phase based on vehicle information associated with the vehicles 102a, 102b and the traffic signal information associated with the traffic light 104. Responsive to determining the probability, the vehicle 102a may output (e.g., via a vehicle Human-Machine Interface (HMI) or infotainment system) the notification to a vehicle driver, so that the vehicle driver may accordingly move the vehicle 102a. By being aware of the probability of the vehicle 102a crossing the traffic light 104 in the green phase, the vehicle driver may not drive too fast (or abruptly slow down or stop vehicle movement) in proximity to the traffic light 104, thereby enhancing vehicle driver convenience and convenience of other drivers in proximity to the vehicle 102a.

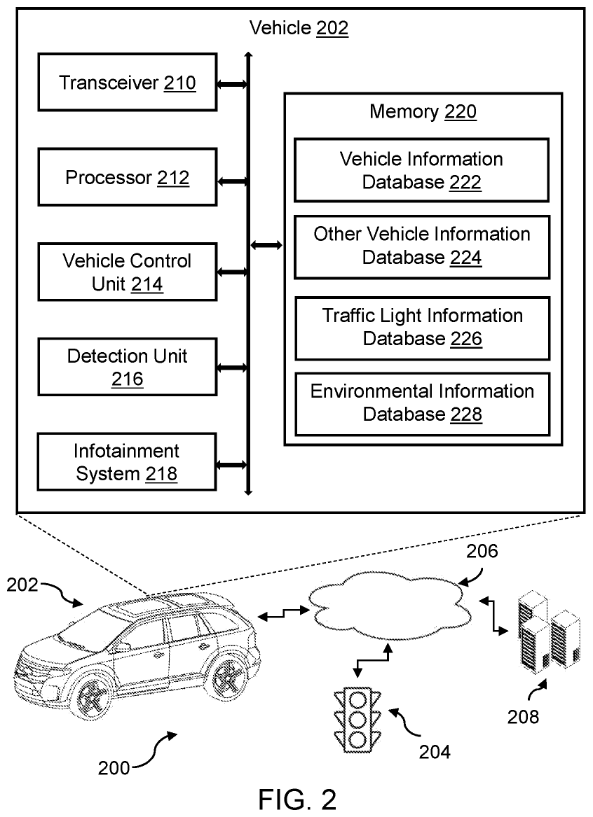

In some aspects, to determine the probability described above, the vehicle 102a may store or “pre-store” vehicle information (e.g., first vehicle information) associated with the vehicle 102a in a vehicle memory (shown as memory 220 in FIG. 2). The first vehicle information may include, for example, historical rate of change of speed profile associated with the vehicle 102a, a first vehicle weight, a first vehicle length, a first vehicle tire condition, a first vehicle propulsion type, and/or the like.

In some aspects, the historical rate of change of speed profile may be based on (and may indicate) a vehicle type, e.g., whether the vehicle 102a is an electric vehicle (EV), a diesel-based internal combustion engine (ICE) vehicle, a gasoline-based ICE vehicle, a fuel cell vehicle (FCV), and/or the like. When the historical rate of change of speed may be greater than a threshold value, the historical rate of change of speed may indicate that the vehicle 102a may be an EV (as the rate of change of speed of an EV is typically is greater than an ICE vehicle). Similarly, when the historical rate of change of speed may be less than the threshold value, the historical rate of change of speed may indicate that the vehicle 102a may be an ICE vehicle. In addition, the historical rate of change of speed profile may be based on weather condition, road conditions, payload weight, tire health, etc. The vehicle 102a may use the historical rate of change of speed profile (along with other parameters/information) to determine whether the vehicle 102a may cross the traffic light 104 in the green phase, as described below.

The vehicle 102a may further include a processor (e.g., a processor 212 shown in FIG. 2) that may obtain the real-time traffic signal information associated with the traffic light 104 from a traffic light controller (not shown) installed in the traffic light 104 and/or a traffic light control server. The real-time traffic signal information may be traffic signal phase and timing (SPaT) information associated with the traffic light 104. The SPAT information may include information associated with a current signal phase (e.g., red phase, green phase etc.) that may be displayed on the traffic light 104 and associated timing of each phase (e.g., green light duration in which the green light may be active/ON, red light duration on which the red light may be active/ON). As an example, the real-time traffic signal information/SPaT information may indicate that the traffic light 104 may be currently operating in the red phase, associated red phase time duration, and time duration associated with the green phase (or “green light duration”) that may follow the red phase.

In addition to obtaining the real-time traffic signal information, the processor may further obtain information associated other vehicles in a vehicle queue in proximity to the traffic light 104. For example, the processor may obtain second vehicle information associated with the second vehicle 102b that may be located in front of the vehicle 102a (as shown in FIG. 1). The second vehicle information may include an estimated time duration (e.g., a first estimated time duration) required by the second vehicle 102b to cross the traffic light 104 (e.g., to cross a centerline 106 of an intersection at which the traffic light 104 may be disposed). In addition, the second vehicle information may include, for example, a first distance the second vehicle has to travel to cross the centerline 106, a second vehicle propulsion type, and a position of the second vehicle 102b in the vehicle queue.

The processor may estimate a time duration (e.g., a second time duration) required by the vehicle 102a to cross the traffic light 104 (e.g., the centerline 106) based on the first vehicle information (including the historical rate of change of speed profile) and the second vehicle information (including the first estimated time duration). Responsive to estimating the second time duration, the processor may compare the second time duration with the green light duration. The processor may determine a probability of the vehicle 102a crossing the traffic light 104 in the green light duration based on the comparison, and transmit a notification to the vehicle HMI to indicate the probability. As an example, if the second time duration may be considerably less than the green light duration, the processor may transmit the notification indicating that the probability of crossing the traffic light 104 may be high (e.g., greater than a first threshold value, e.g., 80%). On the other hand, if the second time duration may be equivalent to or slightly greater than the green light duration, the processor may transmit the notification indicating that the probability of crossing the traffic light 104 may be low (e.g., less than a second threshold value, e.g., 10% or even 0%). In some aspects, the probability may depend on a difference between the second time duration and the green light duration.

Further details of the vehicle 102a are described below in conjunction with FIG. 2.

The vehicle 102 and the vehicle driver implement and/or perform operations, as described here in the present disclosure, in accordance with the owner manual and safety guidelines. In addition, any action taken by the vehicle driver should comply with all the rules specific to the location and operation of the vehicle 102 (e.g., Federal, state, country, city, etc.). The notifications or recommendations, as provided by the vehicle 102, should be treated as suggestions and only followed according to any rules specific to the location and operation of the vehicle 102.

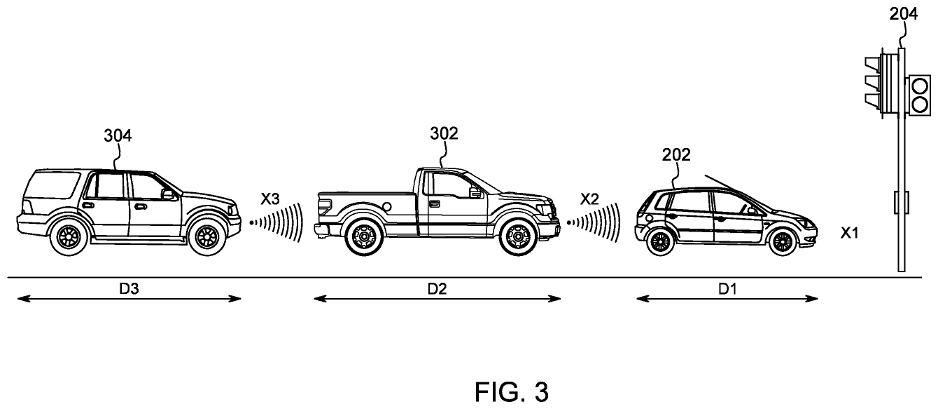

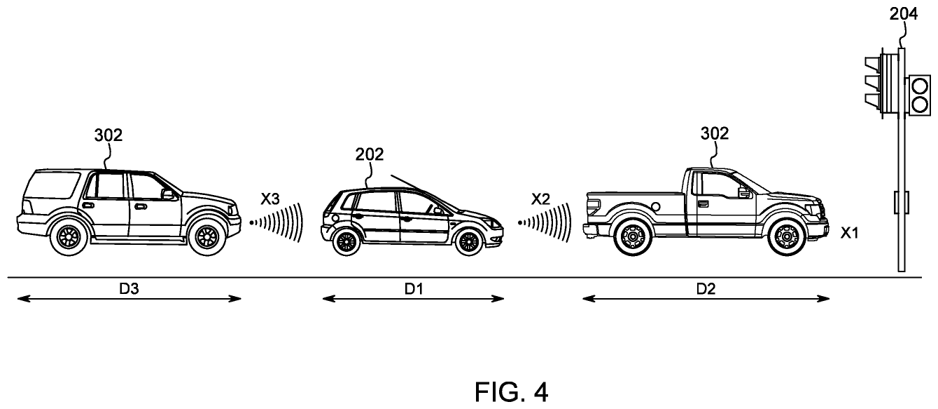

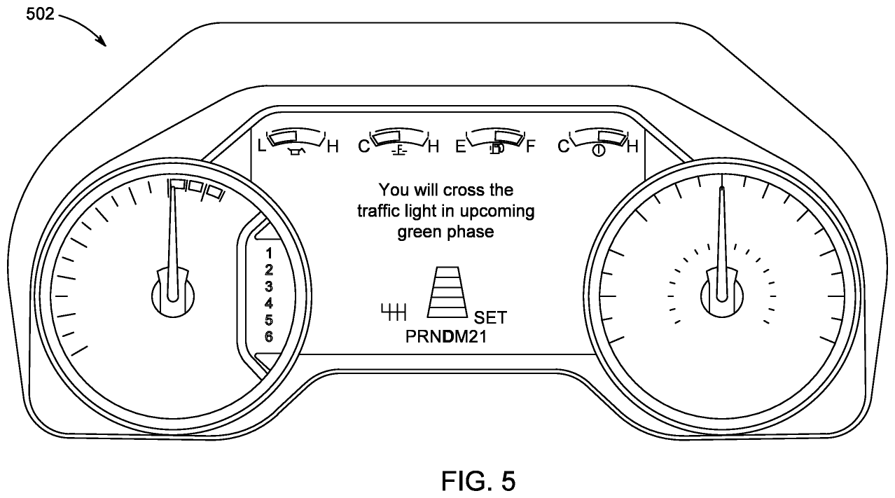

FIG. 2 depicts a block diagram of a system 200 for predicting a vehicle probability to cross a traffic light (e.g., a traffic light 204 described below) in accordance with the present disclosure. While describing FIG. 2, references will be made to FIGS. 3-5. FIGS. 3 and 4 depict first and second example snapshots of a plurality of vehicles disposed in a queue in proximity to the traffic light 204, and FIG. 5 depicts an example message being displayed on a vehicle infotainment system.

The system 200 may include a plurality of vehicles (shown as a vehicle 202 (or a first vehicle 202) in FIG. 2, which may be same as the vehicle 102 described above) and the traffic light 204 that may be communicatively coupled to each other via one or more networks 206 (or network 206). In an exemplary aspect, the vehicles may communicate with each other via vehicle-to-vehicle (V2V) communication, and the vehicles may communicate with the traffic light 104 via V2X (vehicle to everything) communication. In some aspects, the first vehicle 202 may be configured to obtain the real-time traffic signal information associated with the traffic light 204, from the traffic light 204 via V2X communication.

The system 200 may further include one or more servers 208 (or server 208) that may be communicatively coupled with the first vehicle 202 and the traffic light 204 via the network 206. In some aspects, the server 208 may be part of a cloud-based computing infrastructure and may be associated with and/or include a Telematics Service Delivery Network (SDN) that provides digital data services to the first vehicle 202 and other vehicles (not shown in FIG. 2) that may be part of a vehicle fleet. In some aspects, the server 208 may be a traffic light control server that may be configured to determine real-time traffic signal information associated with a plurality of traffic lights (including the traffic light 204), and transmit the real-time traffic signal information to the first vehicle 202 when the first vehicle 202 may be located in proximity to the traffic light 204 or when the first vehicle 202 transmits a request to the server 208 to fetch/obtain the real-time traffic signal information.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The first vehicle 202 may include a plurality of units including, but not limited to, a transceiver 210, a processor 212, a vehicle control unit (VCU) 214, a detection unit 216, a vehicle HMI or infotainment system 218, a memory 220, and/or the like, which may be communicatively coupled with each other. The transceiver 210 may be configured to receive/transmit data/information/signals from/to external systems and devices via the network 206. For example, the transceiver 210 may transmit or receive information/signals to/from other vehicles, the traffic light 204, and/or the server 208. The transceiver 210 may be further configured to transmit/receive signals/information to/from the vehicle units described above.

The VCU 214 may include a plurality of Electronic Control Units (ECUs, not shown) that may enable the VCU 214 to control vehicle operational aspects and implement one or more instruction sets received from the processor 212. For example, the VCU 214 may control vehicle speed, vehicle's direction of motion, etc., when the first vehicle 202 may be a fully or a partially autonomous vehicle. The VCU 214 may be further configured to determine real-time vehicle information. In some aspects, the real-time vehicle information may include, but is not limited to, a real-time (or current) vehicle speed, a vehicle movement direction, a vehicle geolocation, and/or the like.

The detection unit 216 may include one or more vehicle sensors including, but not limited to, a Radio Detection and Ranging (RADAR or “radar”) sensor configured for detection and localization of objects inside and outside the first vehicle 202 using radio waves, a Light Detecting and Ranging (“lidar”) sensor, Sound Navigation and Ranging (SONAR) sensor, proximity sensors, vehicle internal and external cameras, etc. In some aspects, the vehicle exterior camera may be configured to capture images of other vehicles in front of the first vehicle 202 or images of a geographical area in proximity to a vehicle front portion. In some aspects, the detection unit 216 may be a part of the VCU 214. In other aspects, the detection unit 216 may be separate from the VCU 214, as shown in FIG. 2.

The infotainment system 218 may include a touchscreen interface portion, and may include voice recognition features, biometric identification capabilities that can identify users based on facial recognition, voice recognition, fingerprint identification, or other biological identification means. In other aspects, the infotainment system 218 may be configured to receive user instructions via the touchscreen interface portion, and/or output or display notifications (including visual and/or audible alert notifications), navigation maps, recommendations, messages, etc. on the touchscreen interface portion.

The processor 212 may be disposed in communication with one or more memory devices disposed in communication with the respective computing systems (e.g., the memory 220 and/or one or more external databases not shown in FIG. 2). The processor 212 may utilize the memory 220 to store programs in code and/or to store data for performing aspects in accordance with the disclosure. The memory 220 may be a non-transitory computer-readable storage medium or memory storing program codes that may enable the processor 212 to perform operations as per the present disclosure.

The memory 220 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 220 may include a plurality of databases including, but not limited to, a vehicle information database 222, other vehicle information database 224, a traffic light information database 226, and an environmental information database 228.

The vehicle information database 222 may be configured to store vehicle information (e.g., first vehicle information) associated with the first vehicle 202. In some aspects, the vehicle information may include, but is not limited to, a historical rate of change of speed profile associated with the first vehicle 202, a vehicle weight, a vehicle length, a vehicle tire condition, a vehicle propulsion type, and/or the like. In some aspects, the historical rate of change of speed profile may be associated with or be different for different vehicle drivers associated with the first vehicle 202. For example, when the first vehicle 202 may be driven by different drivers, the vehicle information may include historical rate of change of speed profiles for each driver.

The other vehicle information database 224 may be configured to store vehicle information (e.g., second vehicle information) associated with other vehicles (such as a second vehicle 302 shown in FIG. 4, which may be same as the second vehicle 102b described above) that may be located in front of the first vehicle 202 in a vehicle queue in proximity to the traffic light 204. In some aspects, the second vehicle information may include an estimated time duration (e.g., a first time duration) required by the second vehicle 302 to cross the traffic light 204. The second vehicle information may further include one or more of a first distance that the second vehicle 302 may be required to travel to cross the traffic light 204, a second vehicle propulsion type, and a second vehicle position in the vehicle queue in proximity to the traffic light 204.

The traffic light information database 226 may be configured to store the real-time traffic signal information associated with the traffic light 204 (e.g., SPAT information associated with the traffic light 204) that the first vehicle 202 may receive from the traffic light 204 or the server 208. The environmental information database 228 may be configured to store information associated with road conditions (associated with a road on which the first vehicle 202 may be travelling), weather conditions of a geographical area where the first vehicle 202 may be located, etc. that the first vehicle 202 may obtain from the server 208 (or the detection unit 216).

In operation, when the first vehicle 202 arrives in proximity to the traffic light 204 and the traffic light 204 may be operating in the red phase, the transceiver 210 may receive the real-time traffic signal information associated the traffic light 204 indicating that the traffic light 204 is operating in the red phase. In some aspects, the transceiver 210 may receive the real-time traffic signal information from a traffic light controller installed in the traffic light 104 (e.g., via V2X communication) and/or a traffic light control server/server 208. In some aspects, the transceiver 210 may transmit a request to the traffic light controller/traffic light control server to provide the real-time traffic signal information associated with the traffic light 204 (e.g., when the first vehicle 202 arrives at the traffic light 204) to the first vehicle 202. Responsive to receiving the request from the transceiver 210, the traffic light controller/traffic light control server may transmit the real-time traffic signal information to the transceiver 210. Responsive to receiving the real-time traffic signal information, the transceiver 210 may store the real-time traffic signal information in the traffic light information database 226.

In addition, the transceiver 210 may obtain the second vehicle information from other vehicles (e.g., the second vehicle 302 as shown in FIG. 4) in front of the first vehicle 202. In this case, the transceiver 210 may transmit a request to the second vehicle 302 to provide the second vehicle information to the transceiver 210, e.g., when the first vehicle 202 arrives in proximity to the traffic light 204. Responsive to receiving the request from the transceiver 210, the second vehicle 320 may transmit the second vehicle information to the transceiver 210. The transceiver 210 may receive and store the second vehicle information in the other vehicle information database 224. In addition, the transceiver 210 may transmit the received real-time traffic signal information and the second vehicle information to the processor 212.

The processor 212 may obtain the real-time traffic signal information and the second vehicle information from the transceiver 210 or from respective memory databases. In addition, the processor 212 may fetch/obtain the first vehicle information from the vehicle information database 222. In addition to obtaining the information described above, the processor 212 may obtain inputs from the detection unit 216 (e.g., vehicle exterior camera) and determine a position of the first vehicle 202 (or “vehicle position”) in the vehicle queue in proximity to the traffic light 204 based on the inputs obtained from the detection unit 216 and/or the second vehicle information. In some aspects, the processor 212 may obtain the inputs from the detection unit 216 and determine the vehicle location when the first vehicle 202 arrives in proximity to the traffic light 204.

As an example, based on the inputs obtained from the detection unit 216, the processor 212 may determine whether the first vehicle 202 is at a first position in the vehicle queue nearest to the traffic light 204 (as shown in FIG. 3), or other vehicles (e.g., the second vehicle 302) may be located in front of the first vehicle 202 (as shown in FIG. 4). When the detection unit 216 detects absence of vehicles in front of the first vehicle 202, the processor 212 may determine that the first vehicle 202 may be located at the first position in the vehicle queue, as shown in FIG. 3. Responsive to determining that the first vehicle 202 may be at the first position, the first vehicle 202 may broadcast the determined vehicle position (i.e., the first position) to another vehicle located behind the first vehicle 202. For example, the first vehicle 202 may broadcast the vehicle position to the second vehicle 302 located behind the first vehicle 202 (as shown in FIG. 3). The second vehicle 302 may receive the vehicle position from the first vehicle 202 (and inputs from respective detection unit of the second vehicle 302), determine its own position in the vehicle queue, and may broadcast the determined vehicle position to further vehicles (e.g., a third vehicle 304 shown in FIG. 3) in the vehicle queue, and so on. In this manner, all the vehicle in the vehicle queue determine their own vehicle position in the vehicle queue based on the inputs from their own detection units and information received from other vehicles in front. In addition, vehicle processors (e.g., the processor 212) of each vehicle may cause respective infotainment systems (e.g., the infotainment system 218) to indicate/display respective vehicle positions in the vehicle queue.

In addition to determining the vehicle location, the processor 212 may calculate a distance the first vehicle 202 may have to travel to cross the traffic light 204 from vehicle's current position/location in the vehicle queue. Specifically, in this case, the processor 212 may calculate a distance (e.g., a “first distance”) that the vehicle 202 may have to travel from its current position/location to the centerline 106.

When the first vehicle 202 may be at the first position in the vehicle queue as shown in FIG. 3, the processor 212 may calculate the first distance by performing a summation of a first vehicle length D1 and a first gap “X1” (shown in FIG. 3) between the first portion and the centerline 106. In some aspects, the processor 212 may obtain the first vehicle length D1 from the first vehicle information and the first gap “X1” from the server 208 (or a connected infrastructure by using V2X communication). Responsive to obtaining the first vehicle length D1 and the first gap “X1”, the vehicle processor 212 may calculate the first distance (“D”) by adding “D1” and “X1”.

Responsive to calculating the first distance, the processor 212 may obtain the historical rate of change of speed profile associated with the first vehicle 202 from the vehicle information database 222. The processor 212 may then calculate/estimate a first time duration required by the first vehicle 202 to cross the traffic light 204 (e.g., the centerline 106) based on the first distance and the historical rate of change of speed profile. An example mathematical expression for calculating the first time duration is illustrated below:

(D1+X1)=½a(t₁²).

where (D1+X1) is the first distance that the first vehicle 202 may have to travel to cross the centerline 106, D1 is the first vehicle length (i.e., length of the first vehicle 202) and X1 is the first gap; a is the rate of change of speed associated with the first vehicle 202 (determined from the historical rate of change of speed profile associated with the first vehicle 202); and t₁ is the first time duration the first vehicle 202 may require to travel to cross the centerline 106.

In this manner, the processor 212 may estimate the first time duration based on the first distance and the rate of change of speed associated with the first vehicle 202. Responsive to estimating the first time duration to cross the centerline 106, the processor 212 may compare the first time duration with the green light duration (obtained from the real-time traffic signal information). Based on the comparison, the processor 212 may determine a probability (or likelihood) of the first vehicle 202 crossing the traffic light 204 in the green light duration (or in the green phase). For example, when the first vehicle 202 estimates that the first vehicle 202 may cover the first distance in 5 secs (the first time duration) and the green light duration is 30 seconds, the processor 212 may determine that the probability of the first vehicle 202 crossing the traffic light 204 in the green light duration is high (or assured, e.g., more than 90%). On the other hand, when the first time duration may be equivalent to or greater than 30 seconds, the processor 212 may determine that the probability of crossing the traffic light 204 in the green light duration/green phase may be low. Stated another way, the processor 212 may determine that the probability to cross the traffic light 204 may be high when the first time duration may be less than the green light duration, and the probability to cross the traffic light may be low when the first time duration may be greater than the green light duration.

Responsive to determining the probability, the processor 212 may output/transmit a notification to the infotainment system 218 to indicate the probability to the vehicle driver. The vehicle driver may accordingly driver the first vehicle 202 based on the notification/probability.

In some aspects, the processor 212 may be further configured to broadcast the calculated first distance and the estimated first time duration to other vehicles (e.g., the vehicles 302 and 304, as shown in FIG. 3) located behind the first vehicle 202 to enable the vehicles 302, 304 to estimate their own time durations to cross the traffic light 204, and their respective probabilities to cross the traffic light 204 in the green phase.

On the other hand, when the processor 212 determines that a vehicle (e.g., the second vehicle 302, as shown in FIG. 4) may be present in front of the first vehicle 202 based on the inputs obtained from the detection unit 216, the processor 212 may determine the vehicle position associated with the first vehicle 202 in the vehicle queue based on the second vehicle information obtained from the second vehicle 302 (which includes the vehicle position associated with the second vehicle 302 in the vehicle queue, as described above). When the processor 212 determines that the first vehicle 202 may not be at the first position and may be at a second position behind the second vehicle 302 (that may be at the first position, as shown in FIG. 4) based on the inputs obtained from the detection unit 216, the processor 212 may obtain the second vehicle information from the second vehicle 302. Specifically, in this case, the processor 212 may obtain a second distance (e.g., D2+X1, as described below) the second vehicle 302 may have to travel to cross the traffic light 204 (or the centerline 106), and a second time duration (e.g., t₂) the second vehicle 302 may require to cross the traffic light 204 from the second vehicle 302. The second vehicle 302 may calculate the second distance and the second time duration in the same manner as the first vehicle 202 calculates the first distance and the first time duration described above.

In some aspects, when the first vehicle 202 is at a second position (or any other position other than the first position, as shown in FIG. 4), the processor 212 calculates the first distance the first vehicle 202 has to cover to cross the traffic light 204 based on the second distance the second vehicle 302 has to cover to cross the traffic light 204. Similarly, the processor 212 calculates the first time duration the first vehicle 202 may require to cross the traffic light 204 based on the second time duration the second vehicle 302 may require to cross the traffic light 204 (and based on the first distance).

As an example, as depicted in FIG. 4, the second vehicle 302 may determine that the second vehicle 302 may have to cover the second distance D2+X1 to cross the traffic light 204, where D2 is a second vehicle length and X1 is the gap between the front portion of the second vehicle 302 and the centerline 106 (which in FIG. 4 is shown as the traffic light 204). Responsive to determining the second distance, the second vehicle 302 may transmit the second distance to the first vehicle 202 (located behind the second vehicle 302 as shown in FIG. 4), and the processor 212 may thus obtain the information associated with the second distance (D2+X1) from the second vehicle 302 (as part of the second vehicle information). The processor 212 may further determine a distance “X2” (or gap “X2”) between the first vehicle 202 and the second vehicle 302 (specifically, a gap between second vehicle 302 rear portion and a first vehicle 202 front portion). In some aspects, the processor 212 may determine the distance “X2” by using inputs obtained from the detection unit 216 (e.g., the sonar sensor). Responsive to obtaining the second distance D2+X1 and determining the distance X2, the processor 212 may calculate the first distance that the first vehicle 202 may have to travel to cross the traffic light 204 as: D2+X2+D1+X1, where D1 is the first vehicle length.

The processor 212 may then calculate/estimate the first time duration the first vehicle 202 may require to cross the traffic light 204 based on the calculated first distance. For example, the processor 212 may calculate the first time duration by using the mathematical expression:

(D2+X1+D1+X2)=½a(t₁²).
where: t₁ is the first time duration the first vehicle 202 may require to cross the centerline 106.

When the first vehicle 202 is at the second position behind the second vehicle 302 as shown in FIG. 4, respective to calculating the first time duration (t₁) as described above, the processor 212 may determine the probability of the first vehicle 202 crossing the traffic light 204 (or the centerline 106) based on the first time duration (t₁) and the second time duration (t₂). As an example, when the second vehicle 302 estimates that the second vehicle 302 may cover the second distance in 6 seconds and the first vehicle 202 estimates that the first vehicle 202 may cover the first distance in 10 seconds, the processor 212 may calculate a mathematical function based on the time durations of 6 seconds and 10 seconds. In an exemplary aspect, the mathematical function may be a summation or addition of 6 seconds (i.e., the first time duration (t₁)) and 10 seconds (i.e., the second time duration (t₂)).

Responsive to determining the mathematical function, the processor 212 may correlate or compare an output of the mathematical function with the green light duration to determine the probability of the first vehicle 202 crossing the traffic light 204 in the green phase. As an example, the processor 212 may add the first time duration (t₁) and the second time duration (t₂), and then compare the sum with the green time duration. The processor 212 may determine the probability to be high or assured if the sum (e.g., 16 seconds) may be less than the green light duration (e.g., 30 seconds). On the other hand, the processor 212 may determine the probability to be low if the sum may be equivalent to or greater than the green light duration.

Responsive to determining that the first vehicle 202 may or may not cross the traffic light 204 in the green phase (i.e., responsive to determining the probability, as described above), the processor 212 may generate a notification for the infotainment system 218 or a command signal for the VCU 214. The processor 212 may then output/transmit the generated notification to the infotainment system 218 or the command signal to the VCU 214.

Responsive to obtaining the notification from the processor 212, the infotainment system 218 may output (e.g., audibly and/or visually) a message based on the notification. For example, as shown in view 502 of FIG. 5, when the processor 212 determines that the probability of the first vehicle 202 crossing the traffic light 204 may be high (e.g., greater than a threshold of 80-85%), the infotainment system 218 may display “You will be able to cross the traffic light in upcoming green phase”. Responsive to hearing or viewing the message, the vehicle driver (not shown) may maneuver vehicle movement accordingly. In further aspects, when the first vehicle 202 may be a fully or a partially autonomous vehicle, responsive to obtaining the command signal from the processor 212, the VCU 214 may autonomously control vehicle movement (e.g., increase or decrease vehicle speed, keeping the vehicle within the lawful speed limit, and at all times at a safe speed for the given conditions) such that the first vehicle 202 may cross the traffic light 204 in the green phase.

Alternatively, when the processor 212 determines that the probability of the first vehicle 202 crossing the traffic light 204 in the green phase may be low (e.g., less than the threshold), the infotainment system 218 may audibly and/or visually output a message, “You will not be able to cross the traffic light in upcoming green phase.” In such a scenario, responsive to viewing/hearing the message, the vehicle driver may activate Adaptive Cruise Control Interaction Mode. When the vehicle driver turns on the Adaptive Cruise Control Interaction Mode, the processor 212 may transmit instructions to the VCU 214 to activate the mode. Responsive to the mode being activated, the VCU 214 may cause the first vehicle 202 to coast and then stop when any object (e.g., another vehicle in front of the first vehicle 202) may be detected.

In additional aspects, the processor 212 may broadcast the information associated with the calculated first distance and first time duration to the third vehicle 304 located behind the first vehicle 202 (as shown in FIG. 4) to enable the third vehicle 304 to calculate its own probability (using third vehicle 304 length “D3” and gap “X3”) in the same manner described above.

Although the description above describes an aspect where the processor 212 determines the first time duration based on the first vehicle information associated with the first vehicle 202 and the second vehicle information associated with the second vehicle 302 (that may be located in front of the first vehicle 202, as shown in FIG. 4), in further aspects, the processor 212 may estimate the first time duration based on the road conditions associated with the road where the first vehicle 202 may be located and weather conditions in a geographical area including the traffic light 204. In this case, the processor 212 may obtain/fetch the road conditions and weather conditions from the environmental information database 228, and may accordingly estimate the first time duration. The processor 212 may then determine the probability of the first vehicle 202 crossing the traffic light 204 in the green phase based on the estimated first time duration, as described above.

Furthermore, although the present disclosure describes an aspect where the processor 212 obtains the real-time traffic signal information from the traffic light controller or traffic light control server to determine the green light duration, in some aspects, the processor 212 may “learn” and itself determine the green light duration associated with the traffic light 204 based on historical SPaT information of the traffic light 204. In this case, the processor 212 may obtain the historical SPaT information associated with the traffic light 204 from the server 208.

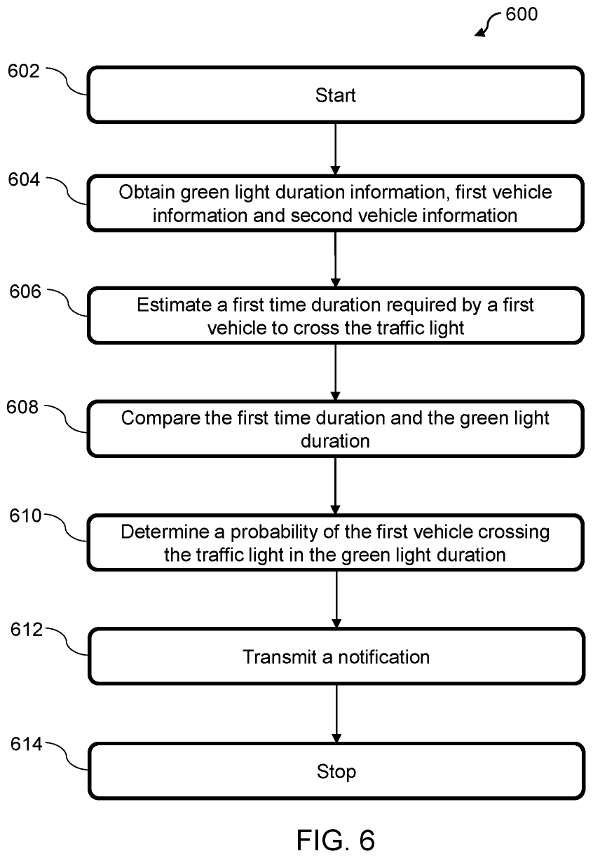

FIG. 6 depicts a flow diagram of an example method 600 for predicting a vehicle probability to cross a traffic light in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 212, green light duration information (associated with a green phase of the traffic light 204), the first vehicle information (associated with the first vehicle 202) and the second vehicle information (associated with the second vehicle 302 located in front of the first vehicle 202). The first vehicle information may include historical rate of change of speed profile associated with the first vehicle 202. The second vehicle information may include a second estimated time duration required by the second vehicle 302 to cross the traffic light 204.

At step 606, the method 600 may include estimating, by the processor 212, a first time duration required by the first vehicle 202 to cross the traffic light 204 based on the first vehicle information and the second vehicle information. At step 608, the method 600 may include comparing, by the processor 212, the first time duration with the green light duration. At step 610, the method 600 may include determining, by the processor 212, a probability of the first vehicle 202 crossing the traffic light 204 in the green light duration based on the comparison. At step 612, the method 600 may include transmitting, by the processor 212, a notification to indicate the probability.

The method 600 may end at step 614.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a memory configured to store first vehicle information comprising historical rate of change of speed profile associated with the first vehicle;
a transceiver configured to:
receive real-time traffic signal information of a traffic light, wherein the real-time traffic signal information comprises green light duration associated with a green phase of the traffic light; and
receive second vehicle information associated with a second vehicle located in front of the first vehicle, wherein the second vehicle information comprises a first time duration for the second vehicle to cross the traffic light;
a processor communicatively coupled to the transceiver, wherein the processor is configured to:
obtain the real-time traffic signal information associated with the green light duration, the second vehicle information and the first vehicle information;
estimate a second time duration required by the first vehicle to cross the traffic light based on the first vehicle information and the second vehicle information;
compare the second time duration with the green light duration;
determine a probability of the first vehicle crossing the traffic light in the green light duration based on the comparison; and
transmit a notification to indicate the probability.

2. The first vehicle of claim 1, wherein the first vehicle information further comprises one or more of: a first vehicle weight, a first vehicle length, a first vehicle tire condition, or a first vehicle propulsion type.

3. The first vehicle of claim 1, wherein the second vehicle information further comprises one or more of: a first distance the second vehicle has to travel to cross the traffic light, a second vehicle propulsion type, or a second vehicle position in a vehicle queue in proximity to the traffic light.

4. The first vehicle of claim 3, wherein the processor is further configured to:
determine a second distance between the first vehicle and the second vehicle; and
calculate a third distance the first vehicle has to travel to cross the traffic light based on the first vehicle information, the second vehicle information, and the second distance.

5. The first vehicle of claim 4, wherein the processor is further configured to broadcast the third distance to a third vehicle located at a rear side of the first vehicle.

6. The first vehicle of claim 5, wherein the processor is configured to estimate the second time duration required to cross the traffic light further based on the third distance.

7. The first vehicle of claim 6, wherein the processor is further configured to broadcast the second time duration to the third vehicle.

8. The first vehicle of claim 1, wherein the processor is further configured to:
obtain information associated with road condition and weather condition; and
estimate the second time duration required to cross the traffic light based on the information associated with the road condition and weather condition.

9. The first vehicle of claim 1 further comprises a detection unit configured to capture images of a geographical area in proximity to a first vehicle front portion.

10. The first vehicle of claim 9, wherein the processor is further configured to:
obtain inputs from the detection unit;
determine a first vehicle position in a vehicle queue based on the inputs from the detection unit and the second vehicle information; and
transmit another notification to indicate the first vehicle position.

11. The first vehicle of claim 1, wherein the processor is configured to determine that the probability to cross the traffic light is greater than a predefined threshold when the second time duration is less than the green light duration, and the probability to cross the traffic light is less than a predefined threshold when the second time duration is greater than the green light duration.

12. A method performed by a first vehicle comprising:
obtaining, by a processor, information associated with a green light duration associated with a green phase of a traffic light, first vehicle information associated with the first vehicle, and second vehicle information associated with a second vehicle located in front of the first vehicle, wherein:
the first vehicle information comprises historical rate of change of speed profile associated with the first vehicle, and
the second vehicle information comprises a first time duration for the second vehicle to cross the traffic light;
estimating, by the processor, a second time duration required by the first vehicle to cross the traffic light based on the first vehicle information and the second vehicle information;
comparing, by the processor, the second time duration with the green light duration;
determining, by the processor, a probability of the first vehicle crossing the traffic light in the green light duration based on the comparison; and
transmitting, by the processor, a notification to indicate the probability.

13. The method of claim 12, wherein the first vehicle information further comprises one or more of: a first vehicle weight, a first vehicle length, a first vehicle tire condition, or a first vehicle propulsion type.

14. The method of claim 12, wherein the second vehicle information further comprises one or more of: a first distance the second vehicle has to travel to cross the traffic light, a second vehicle propulsion type, or a second vehicle position in a vehicle queue in proximity to the traffic light.

15. The method of claim 14 further comprising:
determining a second distance between the first vehicle and the second vehicle; and
calculating a third distance the first vehicle has to travel to cross the traffic light based on the first vehicle information, the second vehicle information, and the second distance.

16. The method of claim 15 further comprising broadcasting the third distance to a third vehicle located at a rear side of the first vehicle.

17. The method of claim 16, wherein estimating the second time duration comprises estimating the second time duration based on the third distance.

18. The method of claim 17 further comprising broadcasting the second time duration to the third vehicle.

19. The method of claim 12 further comprising:
obtaining information associated with road condition and weather condition; and
estimating the second time duration required to cross the traffic light based on the information associated with the road condition and weather condition.

20. A non-transitory computer-readable medium storing computer-executable instructions which when executed by one or more processors result in performing operations comprising:
obtaining information associated with a green light duration associated with a green phase of a traffic light, first vehicle information associated with a first vehicle, and second vehicle information associated with a second vehicle located in front of the first vehicle, wherein:
the first vehicle information comprises historical rate of change of speed profile associated with the first vehicle, and
the second vehicle information comprises a first time duration required by the second vehicle to cross the traffic light;
estimating a second time duration required by the first vehicle to cross the traffic light based on the first vehicle information and the second vehicle information;
comparing the second time duration with the green light duration;
determining a probability of the first vehicle crossing the traffic light in the green light duration based on the comparison; and
transmitting a notification to indicate the probability.
